(19) United States
(12) Patent Application Publication
(10) Pub. No.: US 2018/0255858 A1
(43) Pub. Date: Sep. 13, 2018

(54) KIT FOR CREATING CUSTOMIZED BRIM INSERT FOR UTILITY COVER

(71) Applicant: Michael DaSilva, Long Beach, CA (US)

(72) Inventor: Michael DaSilva, Long Beach, CA (US)

(21) Appl. No.: 15/455,722

(22) Filed: Mar. 10, 2017

(51) Int. Cl. A42B 1/00; G09B 19/24

(52) U.S. Cl. CPC A42B 1/002; G09B 19/24

(57) ABSTRACT

The present disclosure relates to a kit for creating a customized brim insert that supports and expands the brim of a utility or eight-point cover to make it unwrinkled and erect. In accordance with one embodiment of the present disclosure, the kit comprises a rectangular sheet or template having a first set of marking, a second set of marking, a third set of marking and a fourth set of marking on one side of the sheet. The disclosed kit further comprises an instruction that instructs the user on how to cut the rectangular sheet and turn the rectangular sheet into an irregular hexagon that fits and supports the user's utility cover.

### FIELD OF THE DISCLOSURE

The present disclosure generally relates to a brim insert kit for utility and eight point covers. More specifically, the present disclosure provides a kit for creating a customized brim insert that supports and expands the brim of a utility or eight-point cover's panels and crown to make them unwrinkled and erect.

### BACKGROUND OF THE DISCLOSURE

The utility cover, or eight-point cover, (hereafter collectively as “utility cover”) is the authorized US Department of the Navy regulation cover for the United States Navy Working Uniform) and the US Marine Corps Battle Dress Uniform. As shown by FIG. 1, it is generally an eight-pointed hat that comprises a bill 2, a sweatband 4, an eight-sided brim 6, and an eight-sided (or octagonal) crown 8. The cover is worn straight and centered on the head with the sweatband 4 parallel to the deck (the ground).

Most of the time, the fabric of the brim 6 and crown 8 (parts above the sweatband 4) is either issued/bought flat and heavily wrinkled or is misshapen from poor maintenance and/or day-to-day wear and tear. Even if the cover is well maintained, after long use and multiple washings, the backing material for the brim 6 and crown 8 may still lose its stiffness, causing the brim 6 and crown 8 to collapse, giving a sloppy and undesirable appearance.

An octagonal template for supporting the utility cover's overall shape had been introduced by prior art to try to resolve the problems above. The prescribed template is an eight-sided insert that is fitted to the inside crown of the cover. However, this old crown insert has proven problematic for many reasons. For example, the old crown insert acts as a heavy lintel to the brim's already weak unsupported brim posts, resulting in a misshapen brim (the old octagonal template starts at 30 grams an is cut down to 20-25 grams). The old crown insert template also requires at least eight cuts to fit and has a flawed method of measuring. The utility cover sometimes is marked in actual hat sizes but the old crown insert is measured as small, medium, or large. This creates eight confusing and wandering inside angles and different length sides.

If a user manages to fit his or her cover with the old crown insert, the old crown insert works to unseat itself by springing off the top of head or drops out of the hat altogether when the user uncovers his or her head. In addition, a hole is usually cut out where the head touches the old crown insert to allow it to drop down in a properly seated position. Unfortunately, this hole over time cuts into the scalp and compromises the fundamental shape and strength of the insert loosening the fit and allowing the sides to curl.

Due to the insulating properties and the orientation of the traditional crown insert on the head, the insert easily and effectively traps the heads heat thereby creating an unhealthy condition conducive to heat stroke, exhaustion, or complications from other heat related illness for personnel operating in a high heat, high tempo theater (90 F-150 F).

Accordingly, there exists a need for an improved brim insert that fixes or avoids all the aforementioned problems.

### SUMMARY OF THE DISCLOSURE

One objective of the present disclosure is to provide a kit that creates a customized brim insert that fits the forward (or front) brim of a utility or eight-point cover of any size and acts as the brim's support posts to the crowns lintel.

Another objective of the present disclosure is to provide a brim insert kit that has much simpler geometry and requires less cuts than the conventional inserts.

In accordance with one embodiment of the present disclosure, a kit for creating a customized brim insert for a utility cover is disclosed comprising a rectangular sheet (or template) having a first set of marking, a second set of marking, a third set of marking and a fourth set of marking on one side of the sheet. The first set of marking is located at near top and center of the rectangular sheet and has a plurality of graduation lines that are parallel to the rectangular sheet's length. The second set of marking is located on two sides of the first set of marking and has a plurality of graduation lines that intersect with the plurality of graduation lines on the first set of marking and are parallel to the rectangular sheet's width. The third set of marking is located at one corner of the rectangular sheet and has a plurality of graduation lines that are parallel to the rectangular sheet's width. The fourth set of marking is located at another corner of the rectangular sheet and has a plurality of graduation lines that are parallel to the rectangular sheet's width and are symmetrical to the plurality of graduation lines on the third set of marking. The plurality of graduation lines on the third set of marking and fourth set of marking are shorter than the width of the rectangular sheet. The disclosed kit also comprises an instruction that instructs a user to cut the rectangular sheet using the graduation lines and turn the rectangular sheet into an irregular hexagon based on a utility cover's brim size, and to insert the resulting irregular hexagon into the utility cover to support the utility cover's brim and crown.

In the present disclosure, no further holes or modification are necessary for the brim insert after the proper measurements and cuts have been made. The disclosed brim insert is also designed to not contacting the user's skin.

The disclosed brim insert is situated vertically in the forward three brim panels allowing heat to escape through the crown's fabric creating a healthy venting of body heat and reducing risk of stroke, exhaustion, or other heat related illness.

Further, the disclosed brim insert (hexagon template) starts out around 11 grams (or between 8-13 grams) and is cut down to an average of 9 grams or lower (6-10 grams). Thus providing an insert that is smaller and lighter than the conventional octagonal insert, which starts at 30 grams and is cut down to 20-25 grams.

These and other features, aspects and advantages of the present invention will become better understood with reference to the following drawings, description and claims.

### BRIEF DESCRIPTION OF THE DRAWINGS

FIG. 1 is a schematic diagram of a typical utility or eight-point cover.

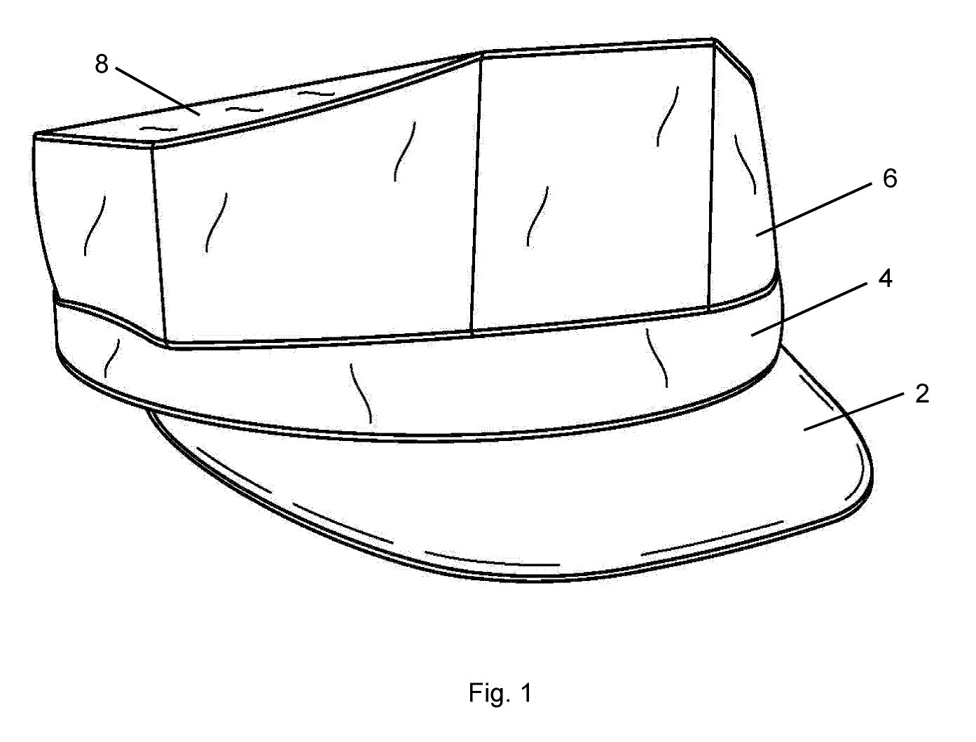

FIG. 2 is a schematic diagram according to an exemplary embodiment of the present disclosure.

FIG. 3 is a schematic diagram according to an exemplary embodiment of the present disclosure.

FIG. 4 is a schematic diagram according to an exemplary embodiment of the present disclosure.

FIG. 5 is a schematic diagram according to an exemplary embodiment of the present disclosure.

FIG. 6 is a schematic diagram according to an exemplary embodiment of the present disclosure.

FIG. 7 is a schematic diagram according to an exemplary embodiment of the present disclosure.

FIG. 8 is a schematic diagram according to an exemplary embodiment of the present disclosure.

FIG. 9 is a schematic diagram according to an exemplary embodiment of the present disclosure.

FIG. 10 is a schematic diagram according to an exemplary embodiment of the present disclosure.

FIG. 11 is a schematic diagram according to an exemplary embodiment of the present disclosure.

FIG. 12 is a schematic diagram according to an exemplary embodiment of the present disclosure.

FIG. 13 is a schematic diagram according to an exemplary embodiment of the present disclosure.

FIG. 14 is a schematic diagram according to an exemplary embodiment of the present disclosure.

FIG. 15 is a schematic diagram according to an exemplary embodiment of the present disclosure.

### DETAILED DESCRIPTION OF THE PREFERRED EMBODIMENT(S) AND DISCLOSURE

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

For purpose of the present disclosure, the term “utility cover” generally refers to an eight-pointed hat that comprises a bill, a sweatband, an eight-sided brim, and an eight-sided crown. The term also includes, but is not limited to, eight-point (8-point) cover.

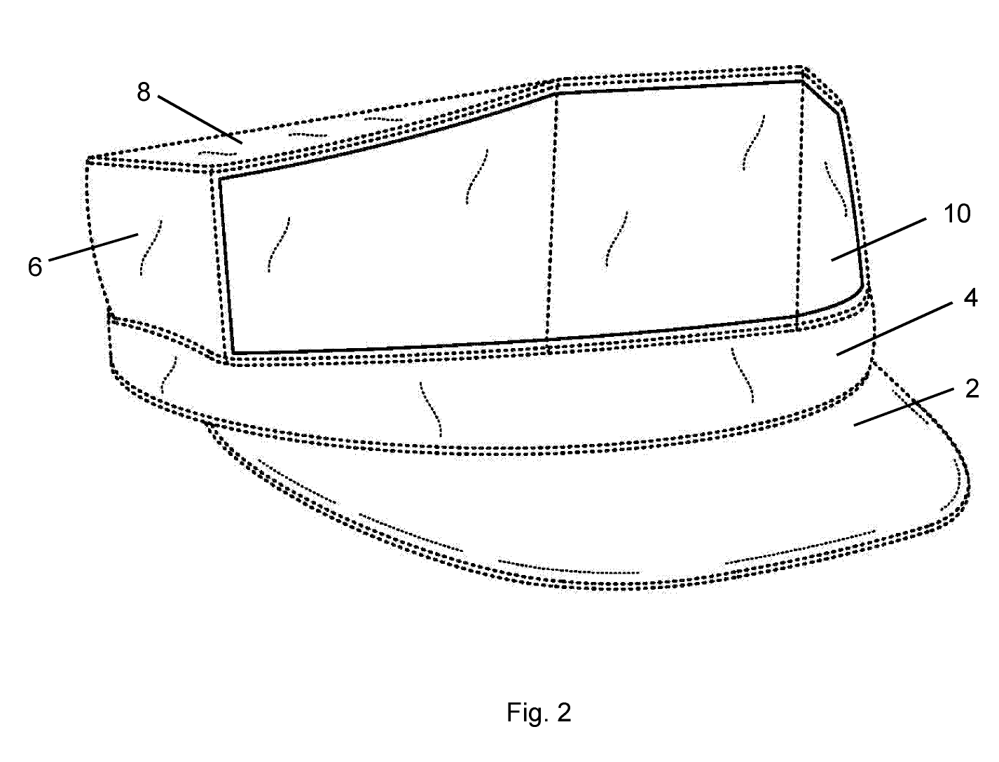

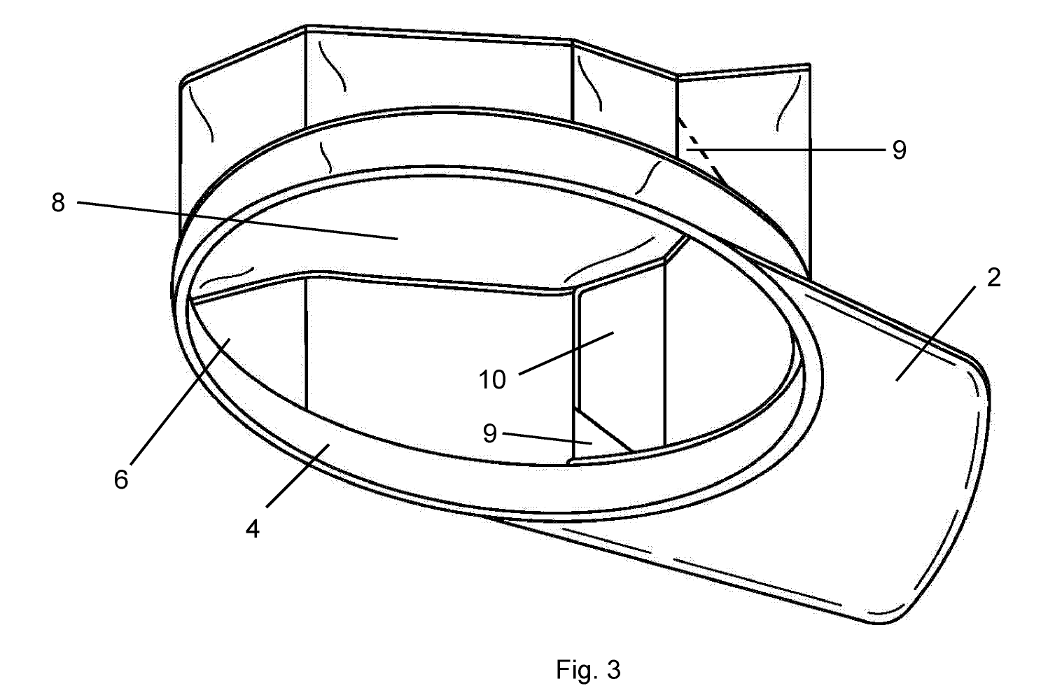

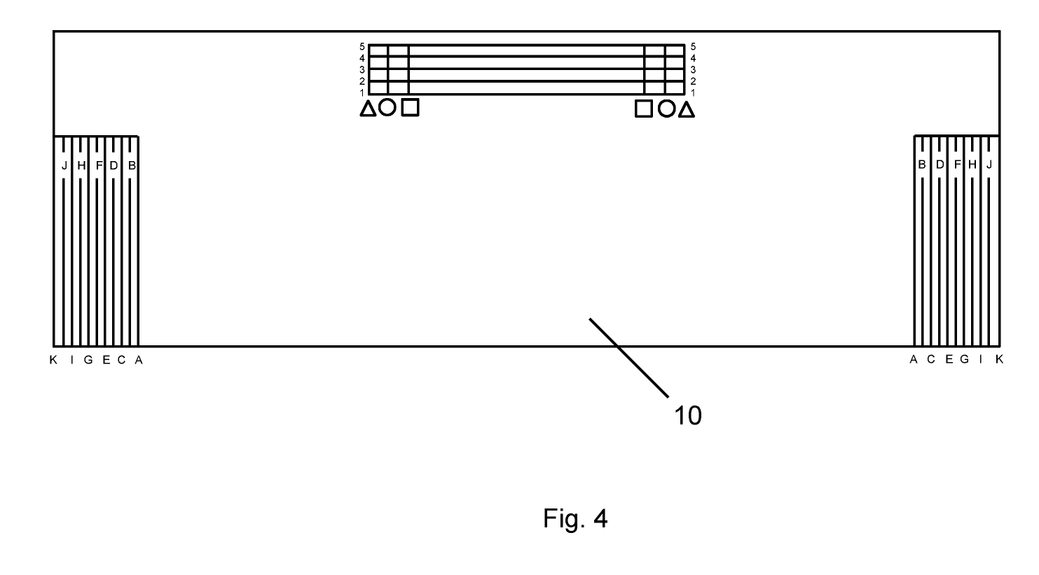

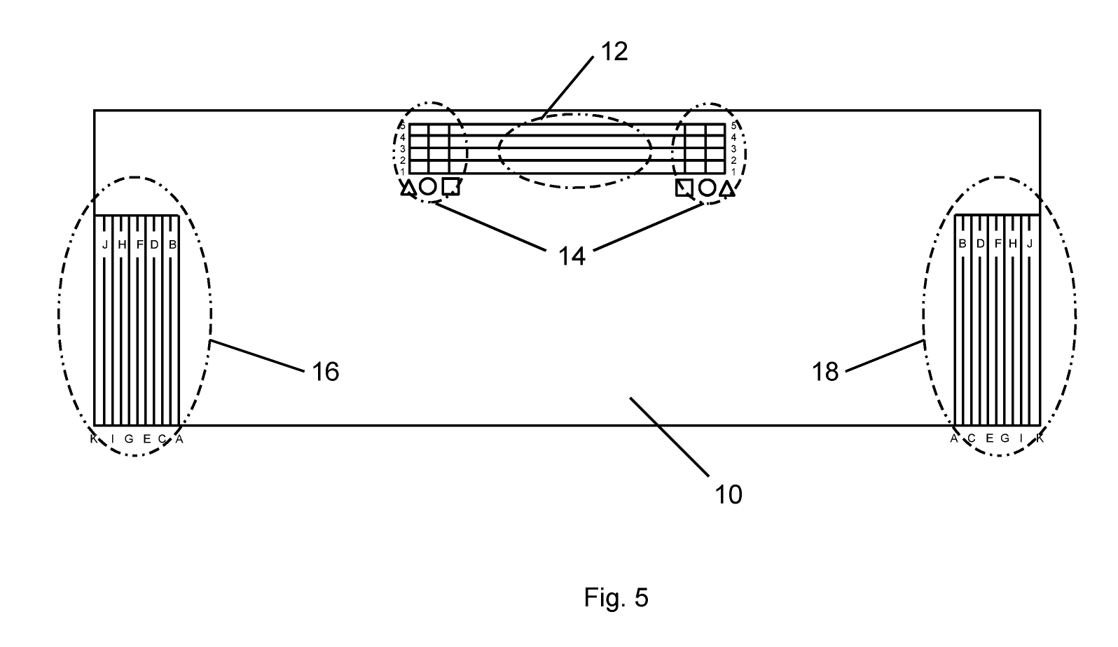

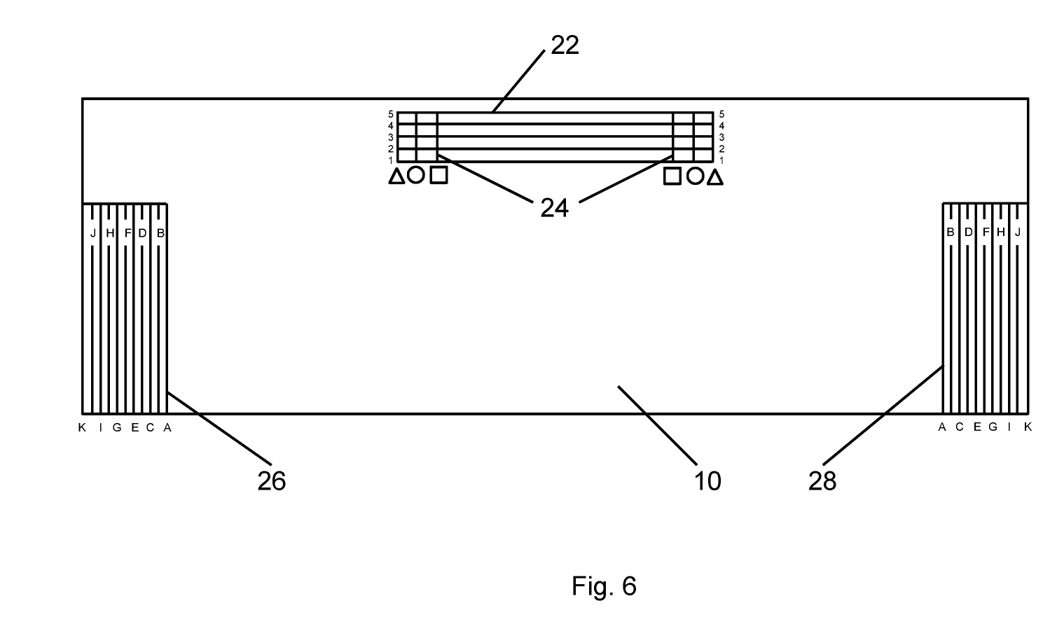

Broadly, embodiments of the present disclosure generally relate to a kit for creating a customized brim insert 10 that supports and expands the brim 6 of a utility cover's panels (or brim) and crown 8 to make them unwrinkled and erect as shown by FIGS. 2 and 3. The disclosed brim insert can be secured and held in place by the two bottom inside right angle flaps 9 of the utility cover as shown by FIG. 3. In one embodiment of the present disclosure, as shown by FIGS. 4 and 5, the kit comprises a rectangular sheet 10 (or a rectangular template) having a first set of marking 12, a second set of marking 14, a third set of marking 16 and a fourth set of marking 18 on one side of the rectangular sheet 10. As shown by FIGS. 5 and 6, the first set of marking 12 is located at top and center of the rectangular sheet 10 and has a plurality of graduation lines 22 that are parallel to the rectangular sheet 10's length. The second set of marking 14 is located on two sides of the first set of marking 12 and has a plurality of graduation lines 24 that intersect with the plurality of graduation lines 22 on the first set of marking 12 and are parallel to the rectangular sheet 10's width. The plurality of graduation lines 22 on the first set of marking 12 are perpendicular to the plurality of graduation lines 24 on the second set of marking 14. The third set of marking 16 is located at one corner of the rectangular sheet 10 and has a plurality of graduation lines 26 that are parallel to the rectangular sheet 10's width. The fourth set of marking 18 is located at another corner of the rectangular sheet 10 and has a plurality of graduation lines 28 that are parallel to the rectangular sheet 10's width and are symmetrical to the plurality of graduation lines on the third set of marking 16. As shown by the figures, the plurality of graduation lines 26 on the third set of marking 16 and the plurality of graduation lines 28 on the fourth set of marking 18 are shorter than the rectangular sheet's width and they do not exceed the first set of marking 12 and the second set of marking 14 on the rectangular sheet 10 from one edge. The graduation lines are there to assist the user to cut the rectangular sheet 10 properly and correctly. The graduation lines may also serve as measurements for the rectangular sheet 10 depending on the design, which will be described in detail below.

The disclosed kit also comprises an instruction (not shown in figures) that instructs a user to cut the rectangular sheet 10 using the graduation lines (22, 24, 26 and 28) and turn the rectangular sheet 10 into an irregular hexagon based on the brim size of the user's utility cover, and to insert the resulting irregular hexagon into the utility cover to support the utility cover's brim and crown. In addition, the plurality of graduation lines 22 on the first set of marking 12, the plurality of graduation lines 26 on the third set of marking 16 and the plurality of graduation lines 28 on the fourth set of marking 18 serve as cut lines for the user. For example, once the user knows the ideal size for his or her brim insert, the user is instructed to cut a line on the first set of marking 12, a line on the third set of marking 16, a line on the fourth set of marking 18, a line connecting the first set of marking 12 and the third set of marking 16, and a line connecting the first set of marking 12 and the fourth set of marking 18 to turn the rectangular sheet 10 into the irregular hexagon. Only five cuts are required at most.

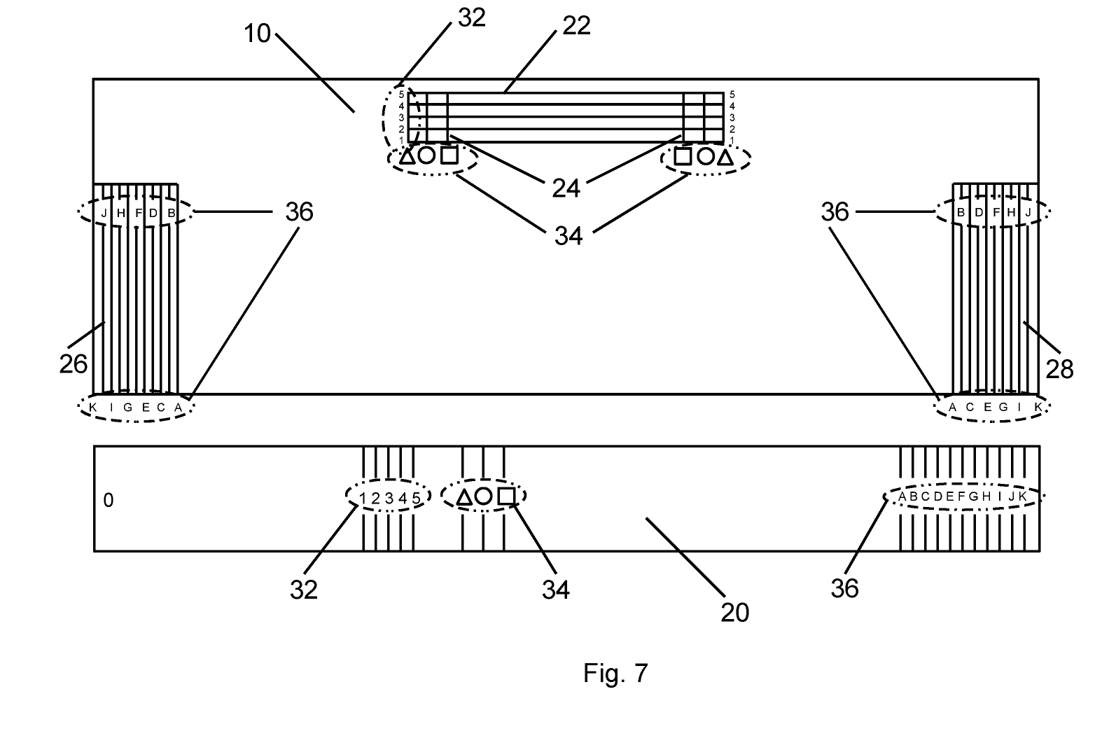

In one embodiment of the present disclosure, as shown by FIG. 7, the disclosed kit further comprises a ruler 20. In this embodiment, the plurality of graduation lines 22 on the first set of marking 12 are denoted by a first set of symbols, shapes, characters or numbers 32 (i.e., 1, 2, 3, 4 and 5), the plurality of graduation lines 24 on the second set of marking 14 are denoted by a second set of symbols, shapes, characters or numbers 34 that are different from the first set of symbols, shapes, characters or numbers 32 (i.e., triangle, circle and square), and the plurality of graduation lines on the third set of marking 16 and fourth set of marking 18 are denoted by a third set of symbols, shapes, characters or numbers 36 that are different from the first set of symbols, shapes, characters or numbers 32 and the second set of symbols, shapes, characters or numbers 34 (i.e., A, B, C, D, E, F, G, H, I, J and K). The ruler 20 also comprises first set of symbols, shapes, characters or numbers 32, second set of symbols, shapes, characters or numbers 34 and third set of symbols, shapes, characters or numbers 36 and their corresponding measurements.

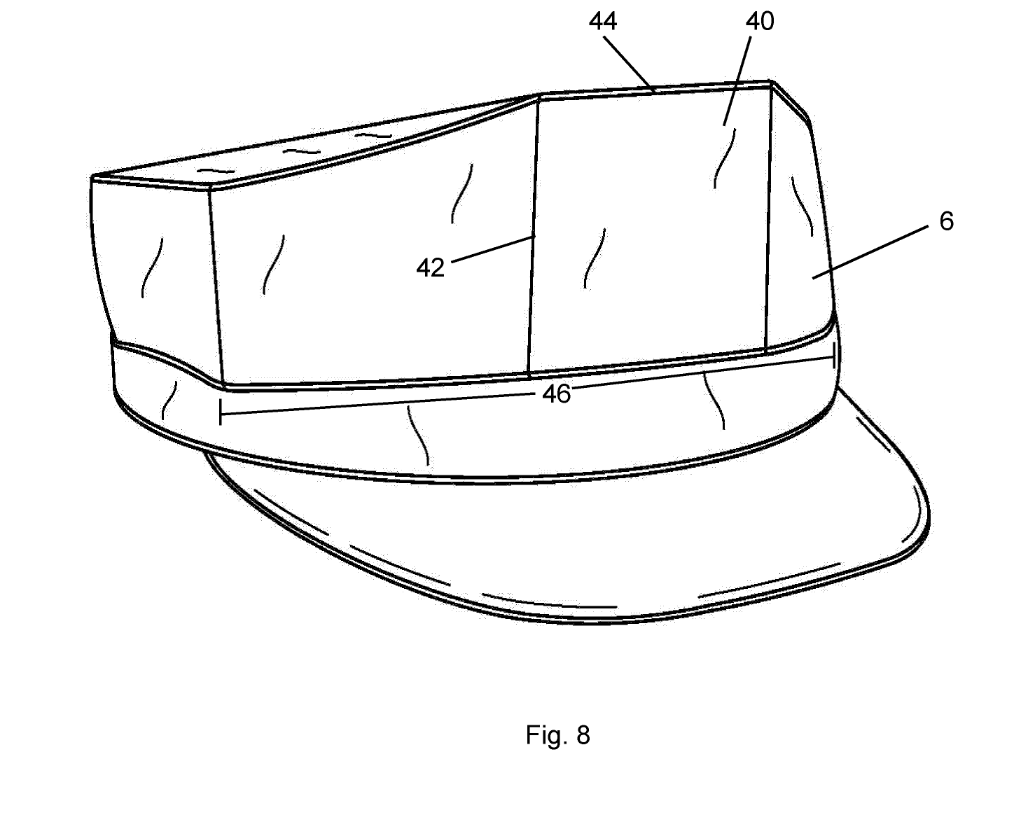

The ruler 20 allows the user to measure the brim size (or the front three panels of the brim) of a utility cover's so that the user knows where to cut on the rectangular sheet 10. In one embodiment, as shown by FIG. 8, the first set of symbols, shapes, characters or numbers 32 on the ruler 20 (i.e., 1, 2, 3, 4 and 5) is used for measuring the height 42 of front and central panel 40 of the brim 6. The second set of symbols, shapes, characters or numbers on the ruler 34 (i.e., triangle, circle and square) is used for measuring the width 44 of front and central panel 40 of the brim. The third set of symbols, shapes, characters or numbers on the ruler 36 (i.e., A, B, C, D, E, F, G, H, I, J and K) is used for measuring the length 46 of front three panels of the brim. Once the user obtains the measurements, the user is only required to cut the corresponding graduation lines on the rectangular sheet 10 to create a brim insert of right size. For example, if the user using the ruler 20 measures “3” for the height 42 of the front and central panel 40 of the brim 6, then the user is instructed to cut the graduation line denoted by “3” on the rectangular sheet 10.

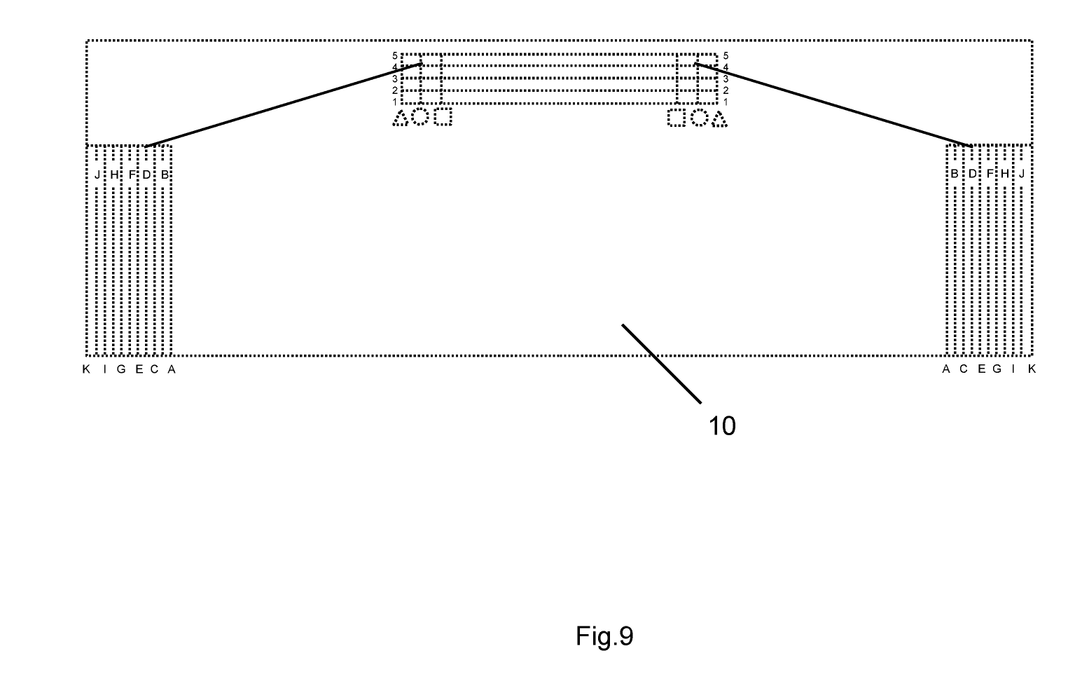

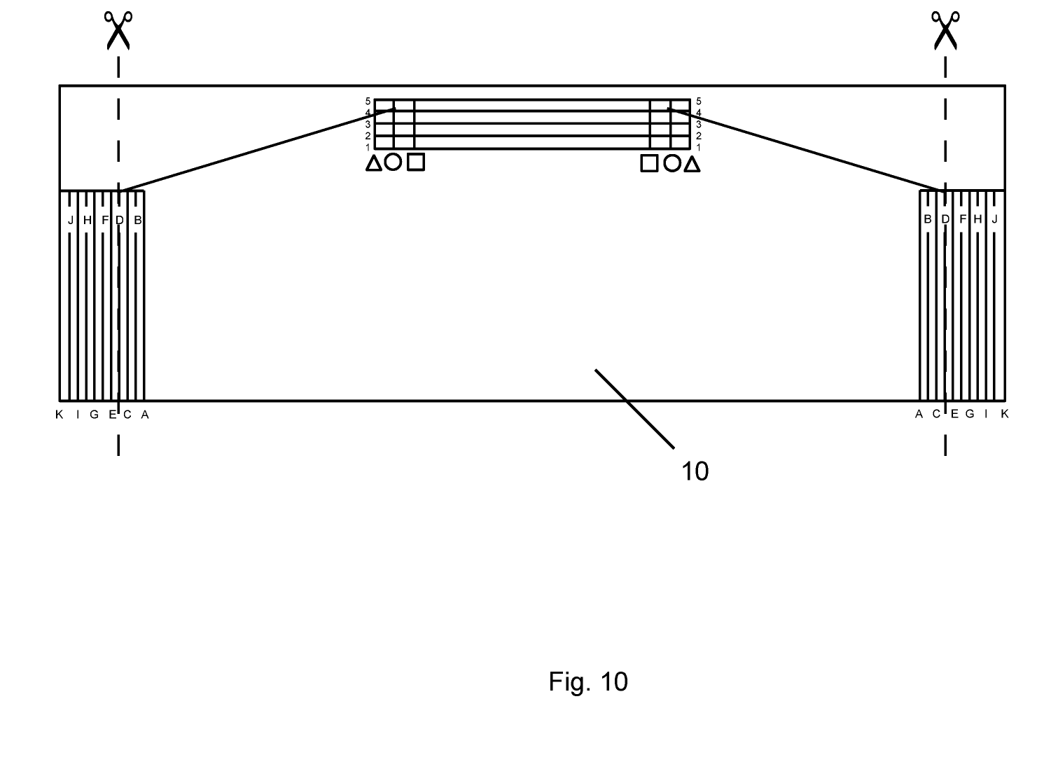

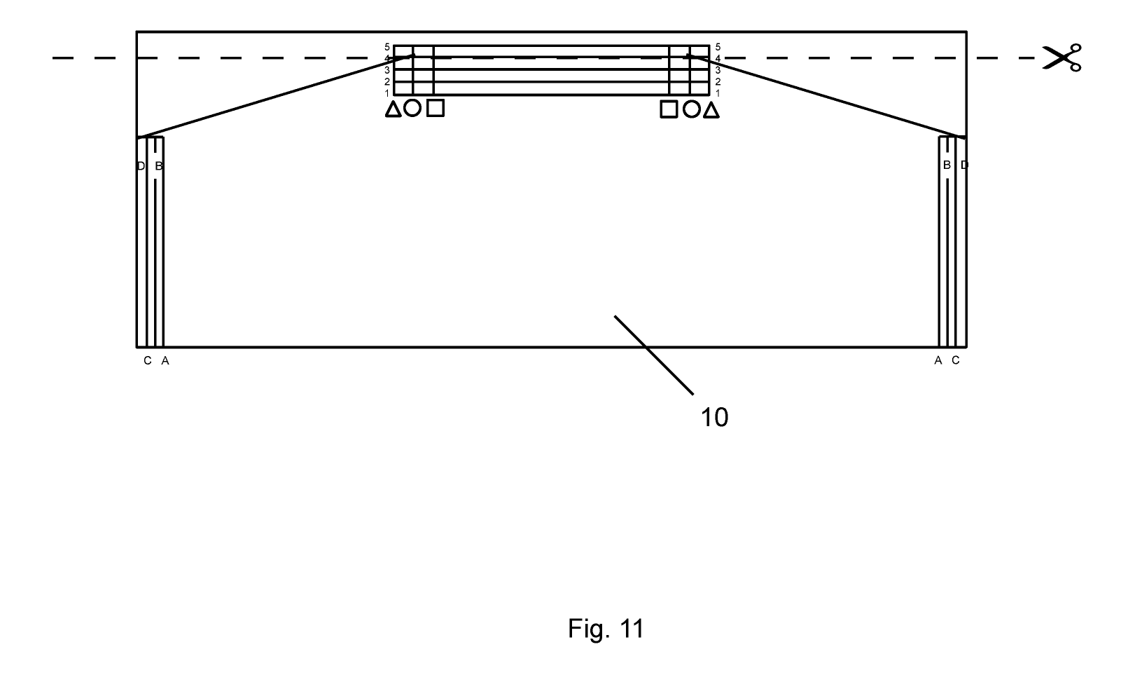

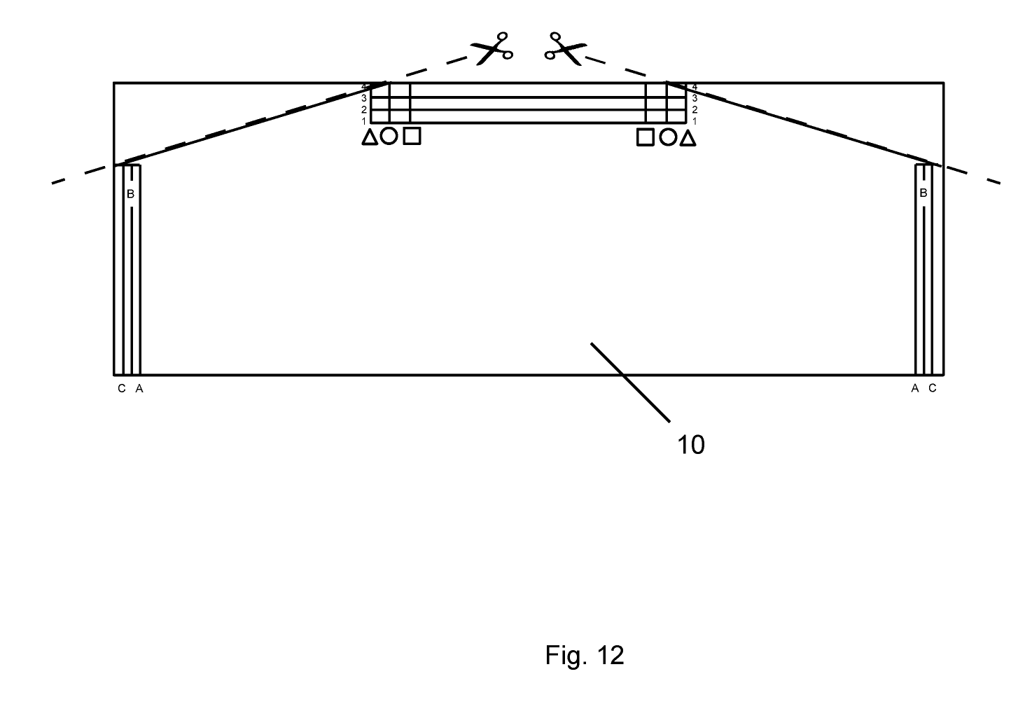

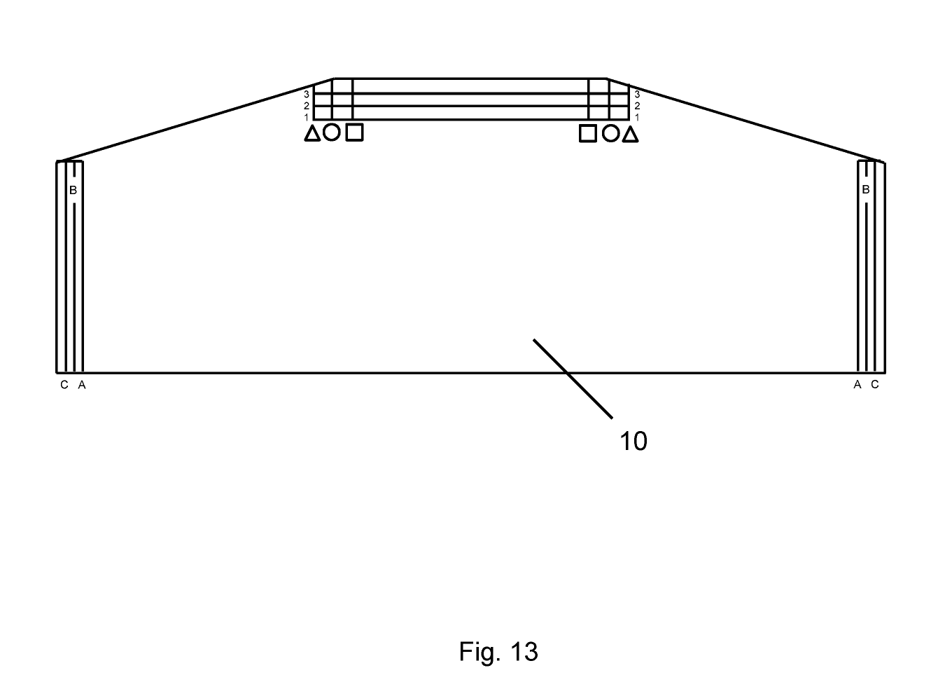

FIG. 9 to FIG. 13 shows an exemplary process of how the rectangular 10 is turned into a brim insert of proper size. Suppose the user measures the height of the front and central panel of the utility cover's brim and obtains “4”, the user measures the width of the front and central panel of the utility cover's brim and obtains symbol “circle”, and the user measures the length of front three panels of the brim and obtains “D”. First, the user can draw a line from the intersection of graduation line “4” on first set of marking 12 and graduation line “circle” on second set of marking 14 to the top of graduation line “D” of third set of marking 16 and fourth set of marking 18 as shown by FIG. 9 (i.e., connect number/shape coordinate to the top (e.g., 4 cm line) of the letter values). Then the user is instructed to cut graduation lines “D” on both side as shown by FIG. 10, the graduation line “4” as shown by FIG. 11, and the two lines drawn by the user as shown by FIG. 12. This turns the rectangular sheet 10 into an irregular hexagon as shown by FIG. 13. Note that there is no particular order of which line should be cut first, it is up to the user and only five cuts are required at most. The user than inserts this resulting irregular hexagon into the forward brim of the user's utility cover (see FIGS. 2 and 3), and the resulting irregular hexagon will serve as a brim insert that supports and expands the brim of the utility cover and make the utility cover's crown and brim unwrinkled and erect.

In yet another embodiment of the present disclosure, the rectangular sheet 10 is made of a material that is flexible but sufficiently rigid for use as a shaping insert in the utility cover. For example, and not by way of limitation, the rectangular sheet 10 can be made of high density copolymer polyethylene resin (HDPE) extruded to the gage of 0.035 in (or between 0.020 to 0.050 in). Advantages of using High Density Polyethylene (e.g., “PE2PRINT”) material includes, but are not limited to: it produces little to no Electro Static Discharge; it is a durable, capable of high resolution graphics, precision die cutting, and lends itself to further development of the rectangular sheet; it has high tensile/tear strength ensures the templates long life; it has allows high-resolution graphics as it is a must for precise fit of properly measured and fitted template; the HDPE is easily die-cut another must for a precision fitted template; and high-resolution graphics will possibly allow custom prints to include: added photos/graphics to back side of template (family, quotes, espirit de corps, etc.).

When old insert (octagonal insert) and the insert of the present disclosure are placed in Electro Motive Force (EMF) producing wear situations within the cover. The old insert is made of a high-impact polystyrene and its ability to hold a charge (permittivity) is represented by its dielectric constant between 2.4-3.1 @MHz compared to new template made of High Density Polyethylene (HDPE) 2.25-2.4 @MHz. Thus, inserts made by HDPE are less likely to produce and hold a charge making it safer.

In yet another embodiment of the present disclosure, each of the plurality of graduation lines 22 on the first set of marking 12 is 0.1 to 0.3 cm apart from adjacent graduation line. Each of the plurality of graduation lines (26 & 28) on the third set of marking 16 and the fourth set of marking 18 is 0.05 to 0.25 cm apart from adjacent graduation line. Each of the plurality of graduation lines 24 of the second set of marking 14 on one side of the first set of marking 12 is 0.3 to 0.7 cm apart. The plurality of graduation lines 24 of the second set of marking 14 on one side of the first set of marking is 4 to 10 cm away from another side (e.g., square to square, circle to circle, or triangle to triangle).

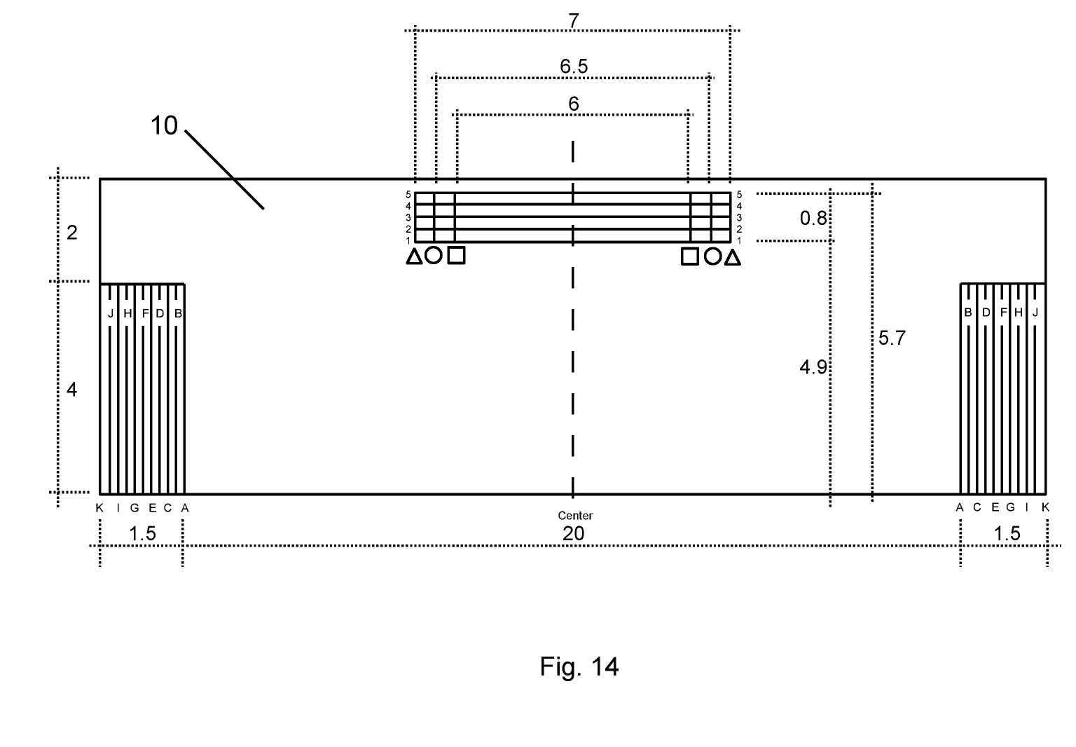

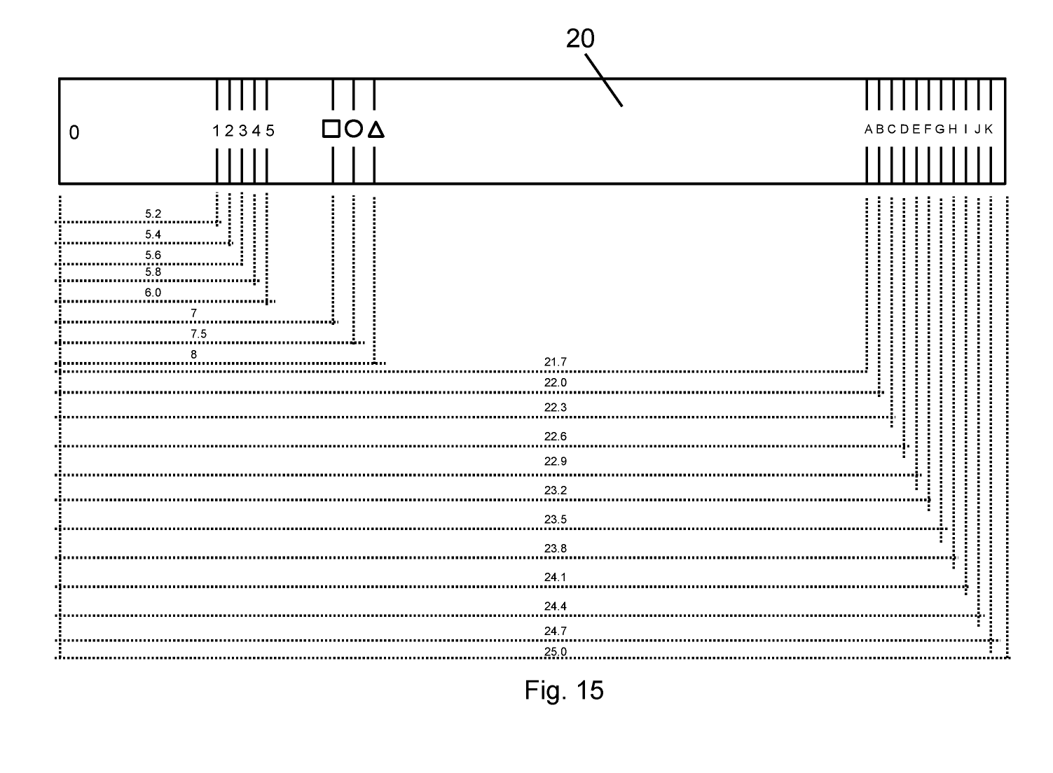

FIGS. 14 and 15 shows exemplary dimensions for all the markings on the rectangular sheet 10 and the ruler 20 according to one embodiment of the present disclosure. In general, ideal length, width and thickness for the rectangular sheet 10 can be somewhere between 20-30 cm, 4-8 cm and 0.03-0.15 cm respectively. In one embodiment, as shown by FIG. 14, the rectangular sheet 10 is 23 cm in length, 6 cm in width and 0.0889 cm in thickness) (or 2.750″×9.000″×0.035″). The first set of marking 12 has five graduation lines 22 that are 0.2 cm apart from adjacent graduation line and each graduation line is 7 cm long. The third set of marking 16 and fourth set of marking 18 have ten graduation lines (26 & 28) each (note border line is not counted as a graduation line here), and the graduation lines are 0.15 cm apart from adjacent graduation line (or border) and each graduation line is 4 cm long. The second set of marking 14 has three graduation lines on one side of the first set of marking 12 that is 0.5 cm apart from adjacent graduation line (e.g., triangle to circle, circle to square) and each graduation line is 0.8 cm long. The plurality of graduation lines 24 of the second set of marking 14 on one side of the first set of marking is 6 to 7 cm away from another symmetrical side (e.g., 6 cm from square to square, 6.5 cm from circle to circle, and 7 cm from triangle to triangle).

In this embodiment, as shown by FIG. 15, the ruler's baseline measurements are about 4-20% larger than the rectangular sheet's 10 baseline measurements (values may vary depending on the design of the rectangular sheet 10). For instance, the distance from triangle to triangle in the second set of marking in FIG. 14 is 7 cm, but the ruler 20 shows that the triangle is 8 cm long from the baseline (increased by approximately 14.3%). The length of “1” in first set of marking in FIG. 14 is 4.9 cm long, but the ruler 20 shows that the length of “1” is 5.2 cm long from the baseline (increased by approximately 6.1%). One reason for increase in the baseline measurements of the ruler 20 is to provide the user with more convenient and accurate measurement for the brim insert. When the user measures the size of a brim from outside of the utility cover, the measured size will be slightly larger than the measurements taken from inside of the utility cover. However, because it is often hard to take measurements from inside the brim, the disclosed ruler 20 allows the user to measure the size of the brim (or brim panels) from outside of the utility cover, and the measured lengths will automatically be reduced on the rectangular sheet 10 so that the rectangular sheet 10 (or the resulting irregular hexagon—brim insert) can fit perfectly into the brim after cut.

Further, measurements taken closer to the sweatband misinformed a proper baseline length. Recognizing the utility cover is constructed from top to down by hand led to the discovery of measuring higher up on the panels generated dimensions that consistently informed a properly fitted template. Thus, in another embodiment, the actual baseline measurements were only good after decreasing measurements by 7%. (Outside baseline×0.93=actual inside template baseline value). In order to obtain outside baseline value a uniform system for measuring a cover needed to be created. The cover needed to be stuffed to “new sofa cushion” like tautness in order to accurately measure the curve and dimensions desired not the ones it already has unsupported.

In yet another embodiment of the present disclosure, the rectangular sheet 10 further comprises a photo insert or print section around the center (or any other area that will not be cut) of the brim insert to allow the user to put or print a photo on it.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A kit for creating a customized brim insert, the kit comprising:
a rectangular sheet having a first set of marking, a second set of marking, a third set of marking and a fourth set of marking on one side;
wherein the first set of marking locates at top and center of the rectangular sheet and has a plurality of graduation lines that are parallel to the rectangular sheet's length;
wherein the second set of marking locates on two sides of the first set of marking and has a plurality of graduation lines that intersect with the plurality of graduation lines on the first set of marking and are parallel to the rectangular sheet's width;
wherein the third set of marking locates at one corner of the rectangular sheet and has a plurality of graduation lines that are parallel to the rectangular sheet's width;
wherein the fourth set of marking locates at another corner of the rectangular sheet and has a plurality of graduation lines that are parallel to the rectangular sheet's width and are symmetrical to the plurality of graduation lines on the third set of marking;
wherein the plurality of graduation lines on the third set of marking and the plurality of graduation lines on the fourth set of marking are shorter than the rectangular sheet's width; and
an instruction that instructs a user to cut the rectangular sheet into an irregular hexagon based on a utility cover's brim size, and to insert the irregular hexagon into the utility cover to support the utility cover's brim and crown.

2. The kit of claim 1, wherein the plurality of graduation lines on the first set of marking are perpendicular to the plurality of graduation lines on the second set of marking.

3. The kit of claim 1, wherein the rectangular sheet is made of high density copolymer polyethylene resin and weighs between 10-12 grams.

4. The kit of claim 1, wherein the instruction instructs the user to cut a line on the first set of marking, a line on the third set of marking, a line on the fourth set of marking, a line connecting the first set of marking and the third set of marking, and a line connecting the first set of marking and the fourth set of marking to turn the rectangular sheet into the irregular hexagon.

5. The kit of claim 1, wherein the plurality of graduation lines on the first set of marking, the plurality of graduation lines on the third set of marking and the plurality of graduation lines on the fourth set of marking serve as cut lines for the user.

6. The kit of claim 1, wherein the plurality of graduation lines on the first set of marking are denoted by a first set of symbols, shapes, characters or numbers, the plurality of graduation lines on the second set of marking are denoted by a second set of symbols, shapes, characters or numbers that are different from the first set of symbols, shapes, characters or numbers, and the plurality of graduation lines on the third set of marking and fourth set of marking are denoted by a third set of symbols, shapes, characters or numbers that are different from the first set and the second set of symbols, shapes, characters or numbers.

7. The kit of claim 6, further comprises a ruler that comprises first set of symbols, shapes, characters or numbers, second set of symbols, shapes, characters or numbers and third set of symbols, shapes, characters or numbers and their corresponding measurements to allow the user to measure the utility cover's brim size using the ruler and cut corresponding graduation lines based on their symbols, shapes, characters or numbers.

8. The kit of claim 7, wherein the ruler's baseline measurements are 4 to 12% larger than the rectangular sheet's baseline measurements.

9. The kit of claim 1, wherein each of the plurality of graduation lines on the first set of marking is 0.1 to 0.3 cm apart from adjacent graduation line.

10. The kit of claim 1, wherein each of the plurality of graduation lines on the third set of marking and the fourth set of marking is 0.05 to 0.25 cm apart from adjacent graduation line.

11. A kit for creating a customized brim insert, the kit comprising:
a rectangular sheet having a first set of marking, a second set of marking, a third set of marking and a fourth set of marking on one side;
wherein the first set of marking locates at top and center of the rectangular sheet and has a plurality of graduation lines that are parallel to the rectangular sheet's length;
wherein the second set of marking locates on two sides of the first set of marking and has a plurality of graduation lines that intersect with the plurality of graduation lines on the first set of marking and are parallel to the rectangular sheet's width;
wherein the third set of marking locates at one corner of the rectangular sheet and has a plurality of graduation lines that are parallel to the rectangular sheet's width;
wherein the fourth set of marking locates at another corner of the rectangular sheet and has a plurality of graduation lines that are parallel to the rectangular sheet's width and are symmetrical to the plurality of graduation lines on the third set of marking;
wherein the plurality of graduation lines on the third set of marking and the plurality of graduation lines on the fourth set of marking are shorter than the rectangular sheet's width;
wherein the plurality of graduation lines on the first set of marking, the plurality of graduation lines on the third set of marking and the plurality of graduation lines on the fourth set of marking serve as cut lines for the user;
wherein the plurality of graduation lines on the first set of marking are denoted by a first set of symbols, shapes, characters or numbers, the plurality of graduation lines on the second set of marking are denoted by a second set of symbols, shapes, characters or numbers that are different from the first set of symbols, shapes, characters or numbers, and the plurality of graduation lines on the third set of marking and fourth set of marking are denoted by a third set of symbols, shapes, characters or numbers that are different from the first set and the second set of symbols, shapes, characters or numbers;
a ruler that comprises first set of symbols, shapes, characters or numbers, second set of symbols, shapes, characters or numbers and third set of symbols, shapes, characters or numbers and their corresponding measurements;
an instruction that instructs a user to measure the utility cover's brim size using the ruler and cut the corresponding graduation lines on the rectangular sheet based on their symbols, shapes, characters or numbers; and
wherein the rectangular sheet is turned into an irregular hexagon and is inserted by the user into the utility cover to support the utility cover's brim and crown.

12. The kit of claim 11, wherein the plurality of graduation lines on the first set of marking are perpendicular to the plurality of graduation lines on the second set of marking.

13. The kit of claim 11, wherein the rectangular sheet is made of high density copolymer polyethylene resin and weighs between 10-12 grams.

14. The kit of claim 11, wherein the ruler's baseline measurements are 4 to 12% larger than the rectangular sheet's baseline measurements.

15. The kit of claim 11, wherein each of the plurality of graduation lines on the first set of marking is 0.1 to 0.3 cm apart from adjacent graduation line.

16. The kit of claim 11, wherein each of the plurality of graduation lines on the third set of marking and the fourth set of marking is 0.05 to 0.25 cm apart from adjacent graduation line.

17. A kit for creating a customized brim insert, the kit comprising:
a rectangular sheet having a first set of marking, a second set of marking, a third set of marking and a fourth set of marking on one side;
wherein the first set of marking locates at top and center of the rectangular sheet and has a plurality of graduation lines that are parallel to the rectangular sheet's length;
wherein the second set of marking locates on two sides of the first set of marking and has a plurality of graduation lines that intersect with the plurality of graduation lines on the first set of marking and are parallel to the rectangular sheet's width;
wherein the third set of marking locates at one corner of the rectangular sheet and has a plurality of graduation lines that are parallel to the rectangular sheet's width;
wherein the fourth set of marking locates at another corner of the rectangular sheet and has a plurality of graduation lines that are parallel to the rectangular sheet's width and are symmetrical to the plurality of graduation lines on the third set of marking;
wherein each of the plurality of graduation lines on the first set of marking is 0.1 to 0.3 cm apart from adjacent graduation line;
wherein each of the plurality of graduation lines on the third set of marking and the fourth set of marking is 0.05 to 0.25 cm apart from adjacent graduation line; and
an instruction that instructs a user to cut the rectangular sheet into an irregular hexagon based on a utility cover's brim size, and to insert the irregular hexagon into the utility cover to support the utility cover's brim and crown.

18. The kit of claim 17, wherein each of the plurality of graduation lines of the second set of marking on one side of the first set of marking is 0.3 to 0.7 cm apart.

19. The kit of claim 17, wherein the rectangular sheet is made of high density copolymer polyethylene resin.

20. The kit of claim 17, wherein the first set of marking has a total of five graduation lines, the second set of marking has a total of six graduation lines, three on each side of the first set of marking, the third set of marking has a total of ten graduation lines and the fourth set of marking has a total of ten graduation lines.
